(19) United States
(12) Patent Application Publication
(10) Pub. No.: US 2015/0357822 A1
(43) Pub. Date: Dec. 10, 2015

(54) INVERTER ELECTRIC GENERATOR SYSTEM AND INVERTER ELECTRIC GENERATOR THEREOF

(71) Applicant: Toshiba Kikai Kabushiki Kaisha, Tokyo (JP)

(72) Inventors: Narutoshi YOKOKAWA, Mishima-shi (JP); Kazumi MURATA, Numazu-shi (JP); Junichi KANAI, Niigata-shi (JP); Naoyuki MASHIMA, Niigata-shi (JP)

(21) Appl. No.: 14/729,641

(22) Filed: Jun. 3, 2015

(30) Foreign Application Priority Data
Jun. 4, 2014 (JP) 2014-115429

(51) Int. Cl. H02J 3/40

(52) U.S. Cl. CPC H02J 3/40

(57) ABSTRACT

An inverter electric generator system is comprised of: master and at least one slave inverter generators, each inverter generator including a communication section, a controller section generating a PWM carrier and an inverter circuit switched by the PWM carrier to generate an alternative current with a controlled voltage and a controlled frequency, the communication sections being mutually connected to exchange a communication data, and the inverter circuits being connected in parallel so as to collect and output the alternative currents as an electric power output, wherein each of the controller sections is configured to synchronize any point of the PWM carrier with any bit of the communication data received by the communication section. The PWM carriers of the master and the slave inverter generators thereby mutually get synchronized.

### CROSS-REFERENCE TO RELATED APPLICATIONS

This application is based upon and claims the benefit of priority from the prior Japanese Patent Application No. 2014-115429 (filed Jun. 4, 2014); the entire contents of which are incorporated herein by reference.

### BACKGROUND OF THE INVENTION

1. Field of the Invention

The present invention relates to an inverter electric generator system and an inverter electric generator applicable thereto, which enable operation and management of a plurality of inverter electric generators connected in parallel.

2. Description of the Related Art

Power supply facilities are frequently required to adjust to changes in electrical demand. Some facility employs a scalable system in which one or more electric generators are additionally connectable in parallel with a primary electric generator and thereby enables scalably adjustable power output.

Use of invertor generators in such a scalable generator system gives rise to some problems because phase differences among PWM carriers in the respective invertors cause non-negligible cross current flow through the parallel connection among the invertors. Such a system therefore requires measures for blocking cross current. Japanese Patent Application Laid-open No. 2003-134834 discloses a related art.

### SUMMARY OF THE INVENTION

The cross current blocking device is of course costly. If phase synchronicity among electric generators was guaranteed, the costly device could be omitted or replaced with a less costly filter. The present invention has been carried out in light of this technical problem.

According to an aspect of the present invention, an inverter electric generator system is comprised of: master and at least one slave inverter generators, each inverter generator including a communication section, a controller section generating a PWM carrier and an inverter circuit switched by the PWM carrier to generate an alternative current with a controlled voltage and a controlled frequency, the communication sections being mutually connected to exchange a communication data, and the inverter circuits being connected in parallel so as to collect and output the alternative currents as an electric power output, wherein each of the controller sections is configured to synchronize any point of the PWM carrier with any bit of the communication data received by the communication section, whereby the PWM carriers of the master and the slave inverter generators mutually get synchronized.

According to another aspect of the present invention, an inverter generator is usable with another inverter generator connected in parallel. The inverter generator is comprised of: a communication section capable of exchanging a communication data with a communication section of said another inverter generator; a controller section generating a PWM carrier; and an inverter circuit switched by the PWM carrier to generate an alternative current with a controlled voltage and a controlled frequency, wherein the controller section is configured to synchronize any point of the PWM carrier with any bit of the communication data received by the communication section, whereby the PWM carrier gets synchronized with a PMW carrier of said another inverter generator.

### BRIEF DESCRIPTION OF THE DRAWINGS

FIG. 1 is a block diagram of an inverter electric generator system according to an embodiment of the present invention.

FIG. 2 is a block diagram of an inverter electric generator applicable to the inverter electric generator system.

FIG. 3 is a timing chart of communication data transmission from respective controllers.

FIG. 4 is a timing chart with wave forms of PMW carriers before and after synchronizing.

FIG. 5 is a block diagram of a calculator for calculating a counted value from measured phase differences.

FIG. 6 is a flowchart showing a process, for synchronization in the invertor electric generator system.

FIG. 7 is a block diagram of the inverter electric generator system, which particularly shows a data communication flow among electric generators.

FIG. 8 is a block diagram of a power controller section applicable to each controller section.

FIG. 9 is a block diagram of a phase controller section applicable to each controller section.

FIGS. 10A and 10B are block diagrams, which illustrate that absence of phase control causes cross current flow.

FIGS. 11A and 11B are block diagrams, which illustrate that phase control by the inverter electric generator system prevents cross current from flowing.

### DETAILED DESCRIPTION OF THE PREFERRED EMBODIMENT

Certain embodiments of the present invention will be described hereinafter with reference to the appended drawings.

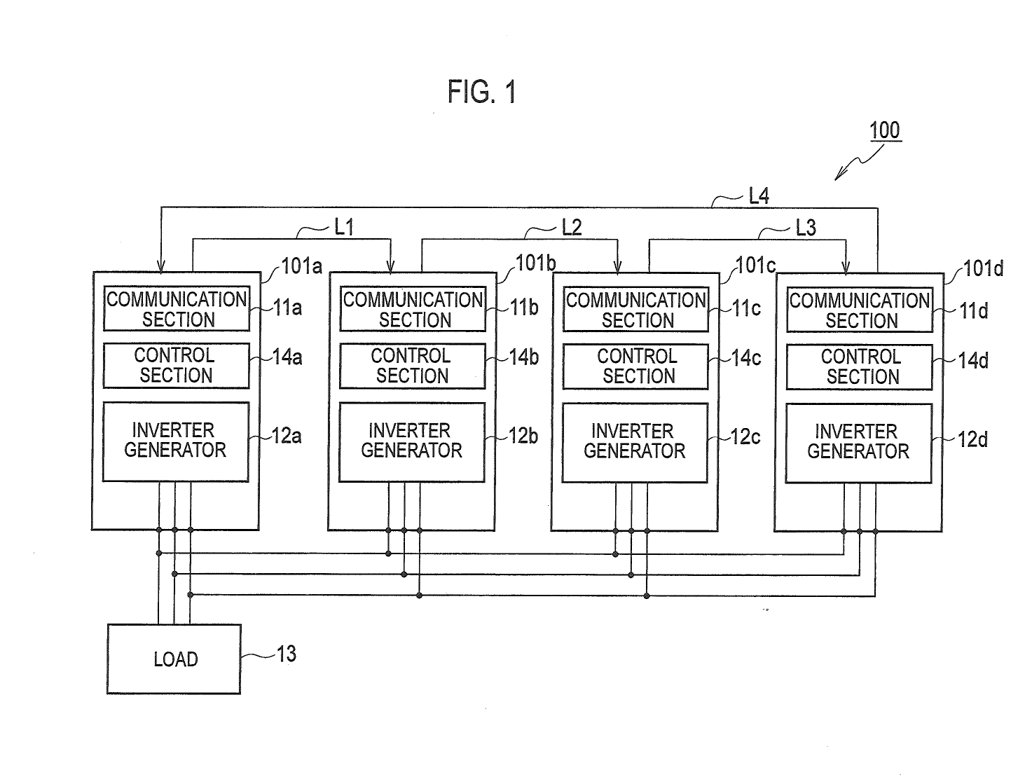

Referring mainly to FIG. 1, an inverter electric generator system 100 according to an embodiment of the present invention is comprised of a primary inverter generator as a master and at least one additional inverter generator as a slave. The example illustrated in FIG. 1 includes one master inverter generator 101a and three slave inverter generators 101b, 101c and 101d, whereas the number of the slave inverter generators is non-limiting and can be arbitrarily scaled up. These master and slave inverter generators 101a-101d may have substantially the same construction or distinctive constructions.

Each inverter generator 101a-101d is comprised of a communication section 11a-11d, a controller section 14a-14d and an inverter circuit 12a-12d, all of which are internally mutually connected by wiring. Further each inverter generator 101a-101d may have a clock generator for generating clock pulses used in timing control of internal logic circuits but an external clock generator is instead available.

Each inverter circuit 12a-12d generates an alternative current (AC) power under control by the controller section 14a-14d. The plural inverter circuits 12a-12d are connected in parallel so as to collect these AC power, thereby outputting them as an output AC power to a load 13. While the illustrated example is of a three-phase three-wire system, a single-phase circuit system is of course applicable.

The communication sections 11a-11d are mutually connected via lines L1-L4, thereby enabling exchange of communication data. The communication data may include an instruction for the voltage, data about phases in the output, and other sequence data which are sent from the master and used for control of the slaves for example. Further the communication data may further include status data and consumed power data which are sent back from the slaves and used for feed-back control for example. While the lines L1-L4 in the illustrated example form the ring topology, the bus topology, the star topology or any other network topology is of course applicable thereto.

Each controller section 14a-14d controls each communication section 11a-11d and each inverter circuit 12a-12d. Each controller section 14a-14d causes the communication section 11a-11d to exchange the communication data. These controls may be either software-based or hardware-based. Each controller section 14a-14d may be comprised of a storage, a memory and a processor for executing the software.

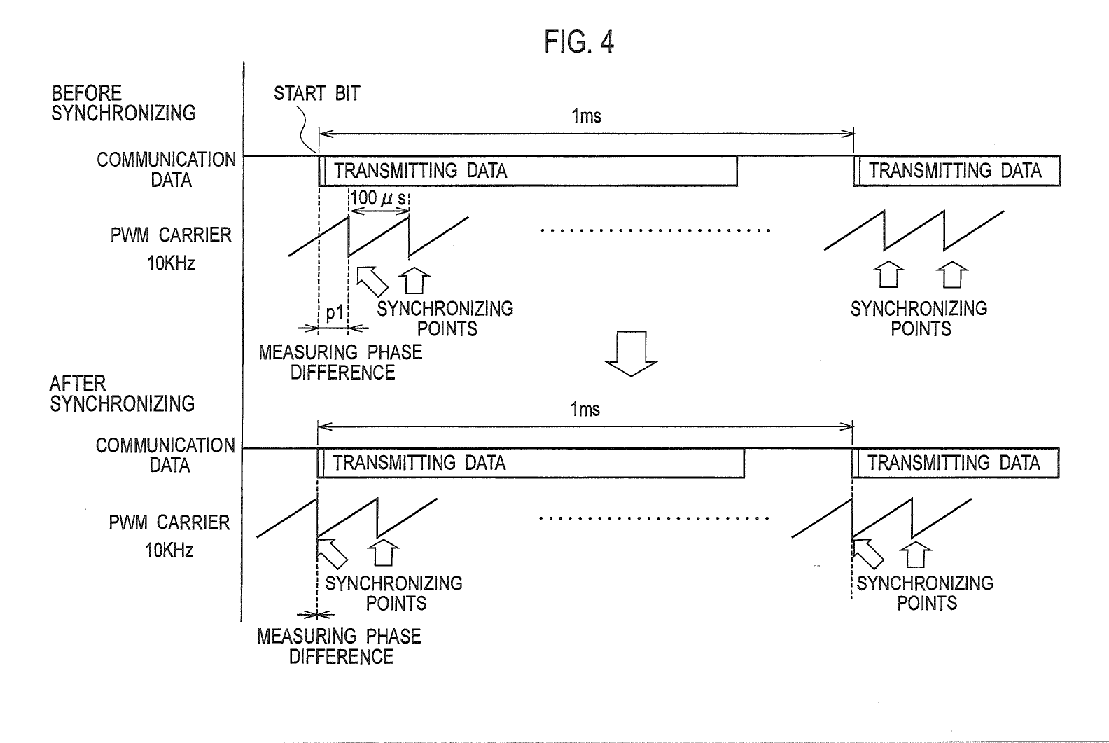

Each controller section 14a-14d may be comprised of signal generators for controllably generating a PWM carrier and a reference AC signal. The PWM carrier is a reference signal for pulse-width modulation (PWM), which has a sawtooth waveform exemplarily shown in FIG. 4 or any proper waveform such as a triangle waveform. The reference AC signal is a sine curve signal, for example, used as another reference. While details will be described later, each inverter circuit 12a-12d uses these signals to generate width-modulated pulses that are smoothed and then output as an AC power. In a case of three-phase AC power generation, each controller section 14a-14d may generate three sets of PWM carriers and reference AC signals.

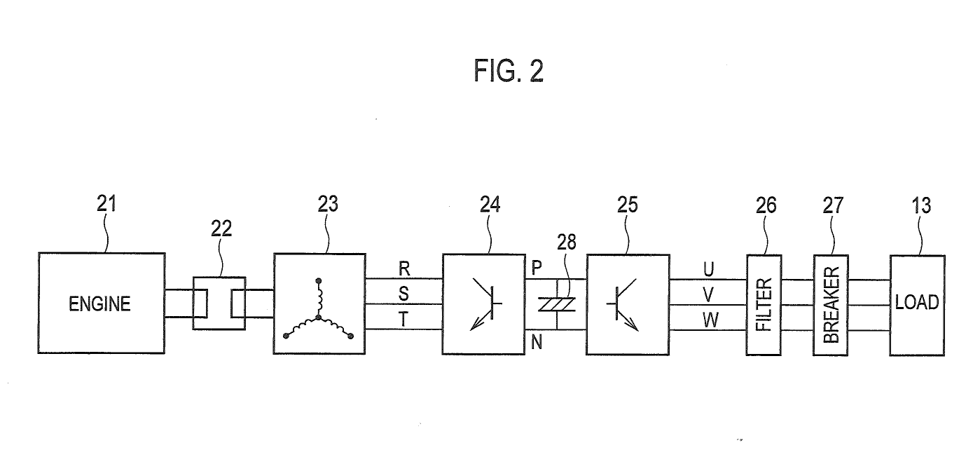

FIG. 2 is an example of a diagram of a circuit for generating an AC power on the basis of the PWM carriers and the reference AC signals. In the circuit, while it is non-limiting, the DC source may be comprised of an engine 21 such as a diesel or gasoline engine, a generator 23 such as a synchronous PM motor and a converter (circuit) 24.

A mechanical coupling 22 may be, although not essential, used for coupling the engine 21 with the generator 23, so that the generator 23 is driven by the engine 21 to generate three-phase alternative currents R,S,T. The converter 24 includes rectifier circuits such as, but not limited to, bridge circuits to convert the three-phase alternative currents into a direct current P,N that is used by the inverter 25. The converter 24 may be so configured as to boost up the output voltage compared with the voltage generated by the generator 23. In between the converter 24 and the inverter 25 connectable is a capacitor 28, which is effective in smoothing the direct current and further adjusting to an instantaneous great power demand.

The inverter 25 may convert the direct current from the aforementioned DC source into three-phase alternative currents U,V,W, whereas the inverter 25 may instead generate single-phase alternative current. These three-phase alternative currents U,V,W are not essentially synchronous with the three-phase alternative currents R,S,T by the generator 23 but are controlled by the PWM carriers.

For converting the DC power into the AC power usable is a set of switching devices such as but not limited to Insulated Gate Bipolar Transistors (IGBT). Each switching device compares the reference AC signal and the PWM carrier and, based thereon, switches between the on-state and the off-state to generate a series of pulses. The pulses are smoothed and then output as the AC power. Thus, by changing the reference AC signal and the PWM carrier under control by the controller section, the inverter 25 can generate the AC power with a controlled voltage and a controlled frequency.

The inverter 25 is connected with the load 13 while the circuit preferably has filters 26 such as LC filters for reducing switching noise and a breaker 27 interposed therebetween, thereby outputting the three-phase AC power to the load 13.

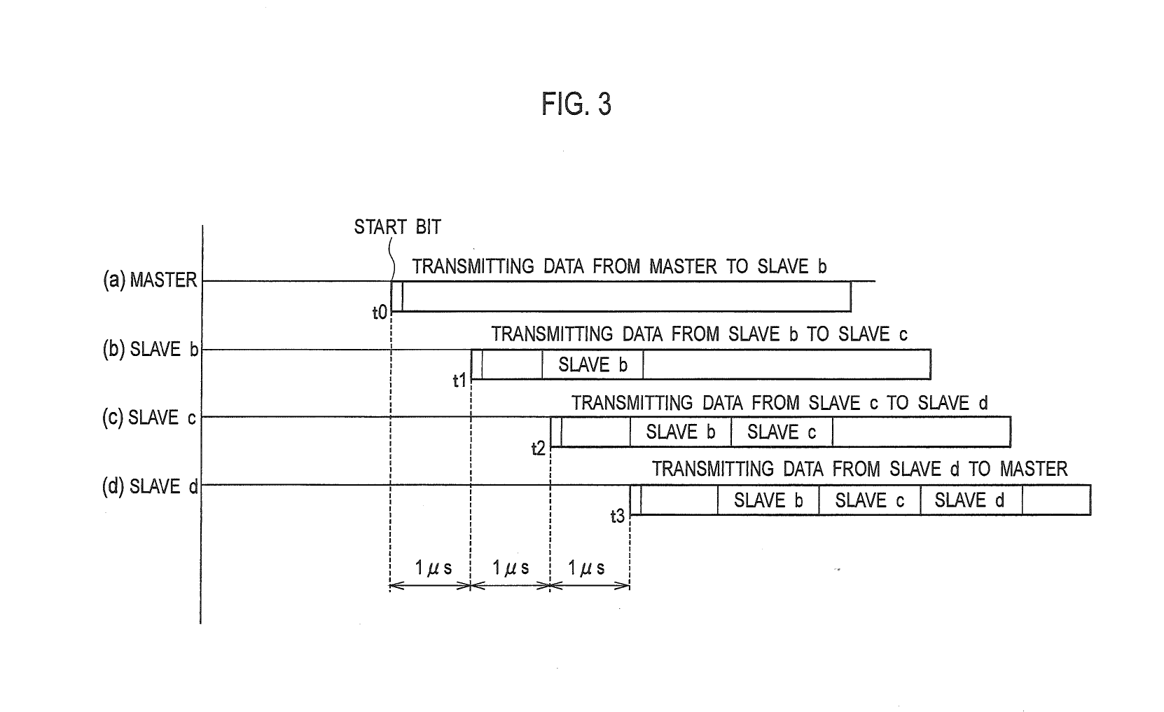

During the power generation, the controller sections 14a-14d exchange the communication data via the communication sections 11a-11d and the lines L1-L4 to commonly own the control data and the respective status data. Referring to FIG. 3, typically the controller section 14a of the master inverter generator 101a causes its communication section 11a to transmit the communication data to the communication section 11b of the slave inverter generator 101b. The controller section 14b receives and updates the communication data by adding its own phase data or such, and next causes its communication section 11b to transmit the updated communication data to the next communication section 11c of the slave inverter generator 101c. The similar processes are sequentially executed by the controller sections 11c and 11d. Further the similar processes are repeated preferably at regular intervals, every 1 millisecond for example, as shown in FIG. 4.

After the series of data exchange, the controller section 14a of the master inverter generator 101a receives fully updated data including all the status data of the inverter generators 101a-101d. The controller section 14a can use these data to control the invertor generators 101a-101d and to next transmit data for executing feed-back control.

As the process execution in the controller sections 14a-14d is relatively fast, the time delays from t0 to t1, from t1 to t2, and from t2 to t3, are relatively short, such as 1 microsecond for example (see FIG. 3). Each time interval for repeating data transmission is far longer, such as 1 millisecond for example (see FIG. 4). The period of the wave of the PMW carrier is far longer than the former but shorter than the latter, such as 100 microseconds for example if its frequency is 10 kHz.

There may be phase differences among the PWM carriers in the respective invertor circuits 12a-12d, which may cause cross currents through the parallel connections among the invertor generators 101a-101d. The present embodiment synchronizes the phases of these PWM carriers to avoid cross current flow. The communication data repeatedly exchanged via the lines L1-L4 is available as a reference for synchronization among the PWM carriers as the time delay for data exchange is substantially negligible as discussed above.

Referring again to FIG. 4, the controller section at issue first measures a time difference between any point in the communication data and any point of the PWM carrier. While the communication data is constituted of a series of data bits, one or more bits arbitrarily selected therefrom may instruct the controller section to start measuring. The first bit thereof is available as the reference point but any succeeding bit is instead available. In regard to the PWM carrier, a falling edge of the carrier wave for example may be readily available. The following description, although not limiting, relates to an example which measures a time difference p1 from the start bit in the communication data to one of the falling edges of the carrier wave (referred to as “synchronizing point” hereinafter).

The controller section, at a time of receiving or transmitting this referred bit, starts counting clock pulses until detecting the synchronizing point. The controller section thus measures a count of the clock pulses after the referred bit until the synchronizing point. The controller section can add the measured count to the communication data in the data updating process.

The controller section next generates correction data for eliminating the time difference p1. Calculation for the correction value is carried out by adding or subtracting a proper value α, typically one, to or from the measured count C1 so as to eliminate the count, unless C1 comes to be zero (there's no phase difference). The controller section then uses the correction data to shift the PWM carrier by the added or subtracted number of clock pulses.

The loop of measuring and shifting is repeated until the phase difference has gone. Of course, this loop could be further repeated after synchronization. All the controller section 14a-14d individually carries out the same process. Then synchronization of the PWM carriers throughout the system can be established. Whereas very small differences among these PWM carriers can remain because there's very short time delays in data exchange, these differences can be negligible because the time delays are far shorter than the periods of the waves of the PMW carriers as discussed above. Or, as the differences are sufficiently small, simple filter circuits can address resultant cross currents. Still alternatively, as the time delays are fixed in advance, the respective controller sections can take these delays into account to synchronize the PWM carriers.

Some modification could accelerate this synchronization process. For example, the measured count C1 can be classified into three cases of:

C1=0 (synchronized),

0<C1≦Cref/2 (the synchronizing point at issue is closer to the referred bit than a preceding synchronizing point is), and

Cref/2<C1<Cref (the preceding synchronizing point is closer to the referred bit), where Cref is the frequency of the clock divided by the frequency of the PWM carrier.

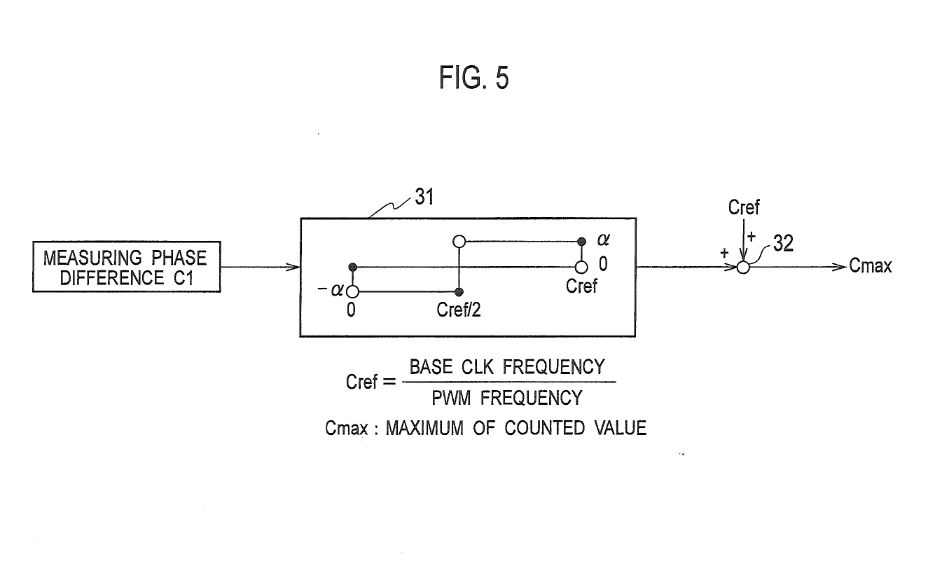

Referring to FIG. 5, the controller section determines which case the measured count C1 falls in, and then, in the case of “0<C1≦Cref/2”, add a negative value α, typically minus one, to the measured count C1 (to shift the phase of the PWM carrier by minus a clock pulses) and, in the case of “Cref/2<C1<Cref”, add a positive value α, typically one, to the measured count C1 (to shift the phase of the PWM carrier by a clock pulses). This scheme of shifting is a shortcut for reaching synchronism. Therefore, when the loop of measuring and shifting is repeated, synchronism of the PWM carriers can be accelerated.

Each controller section 14a-14d may individually execute the processes of measuring the count, calculating the correction value and shifting the PWM carrier. However, any of the controller sections 14a-14d, typically the master controller section 14a, may use the communication data exchange to take over some of the processes by the other controller section, such as the calculation process. Results of calculation are included in the communication data and then sent to the controller sections at issue, and are used for synchronization there.

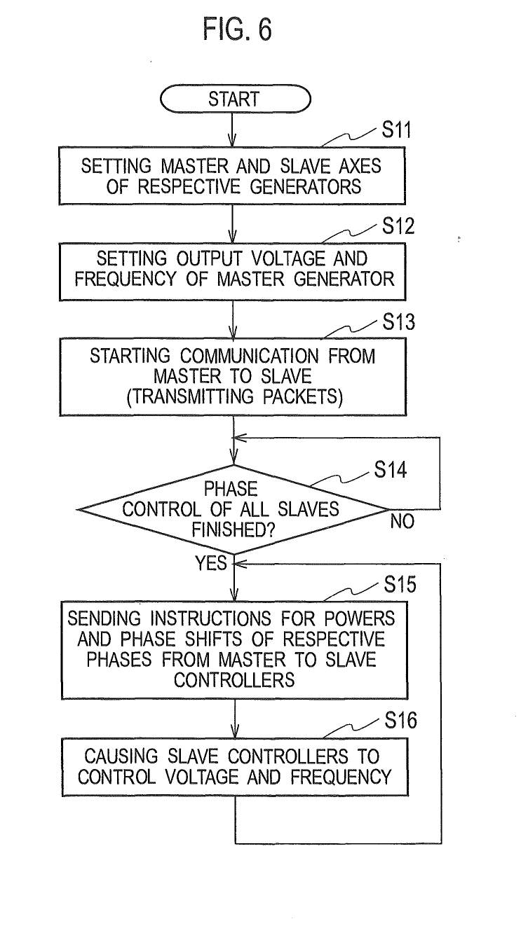

Control of the inverter electric generator system 100 will be described with reference to FIG. 6.

In the step S11, one master is selected from the inverter generators in the system and the others are set as slaves. In the example illustrated in FIG. 1, the inverter generator 101a is the master and the inverter generators 101b-101d are the slaves.

In the step S12, the controller section 14a of the master inverter generator 101a sets an output voltage and a frequency like as 200 V and 50 Hz for example. The steps S11 and S12 may be executed by any person's operation.

In the step S13, the controller section 14a of the master causes the communication section 11a to start communication with the communication sections 11b-11d of the slaves via the lines L1-L4. The controller sections 14b-14d in sequence receives the communication data, updates the communication data by adding the phase data and such thereto, and transmits the updated communication data. The controller sections 14a-14d substantially concurrently use the communication data for synchronizing the synchronizing points (or any arbitrarily selected points) of the PWM carriers with the start bit (or any other bit) of the communication data, thereby synchronizing the PWM carriers mutually, in the way as described above. Synchronization is repeatedly carried out to retain the synchronized state.

In the step S14, the respective controller sections determine whether synchronization of the PWM carriers is established. If YES, the process goes to the step S15, in which the master controller section 14a transmits instructions for powers and phase shifts about the respective phases U,V,W to the respective slave controller sections 14b-14d.

In the step S16, each controller section 14a-14d controls its invertor circuit 12a-12d to output electric power with a controlled voltage, a controlled frequency and a controlled phase angle under control by the communication data. Then, as there's no phase difference among the PWM carriers, cross current is prevented from flowing.

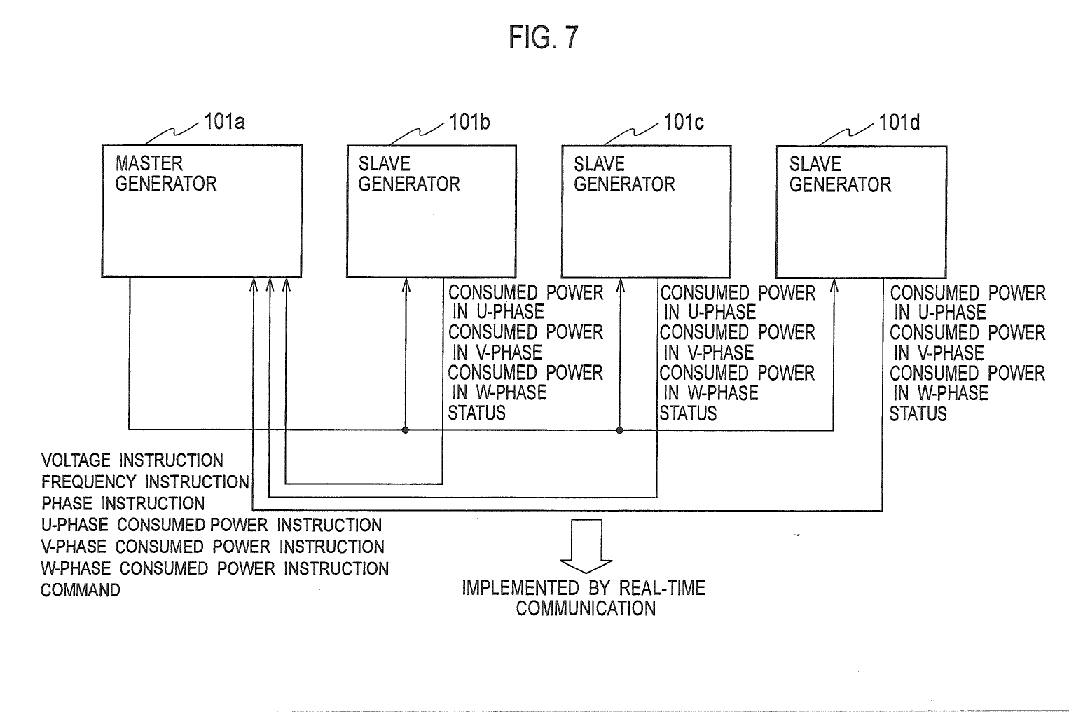

Details of the instructions sent in the step S15 will be described with reference to FIG. 7. The master controller section 14a sets an instruction value for the voltage of the respective inverter generators 12a-12d, such as 200 V, an instruction value for the frequency, such as 50 Hz, and an instruction value for the electrical angle of the master inverter generator 12a, such as 200 degrees.

Further the master controller section 14a sets instruction values of electric powers to be consumed for the U-phase, the V-phase and the W-phase. In a case of load leveling for example, the instruction value of the electric power to be consumed for the U-phase is made to be an average value of the consumed powers of the U-phase in the respective inverter generators. The instruction value of the electric power to be consumed for the V-phase is made to be an average value of the consumed powers of the V-phase in the respective inverter generators. Further, the master controller section 14a transmits information about the instructions for the voltage, the frequency, the phase and the electric powers to be consumed to the respective slave inverter generators 101b-101d. Further the controller section transmits information about commands. The respective slave inverter generators 101b-101d transmit data of the respective consumed powers of the U-,V-,W-phases and these statuses to the master inverter generator 101a.

Each controller section 14a-14d is comprised of a power controller section and a phase controller section.

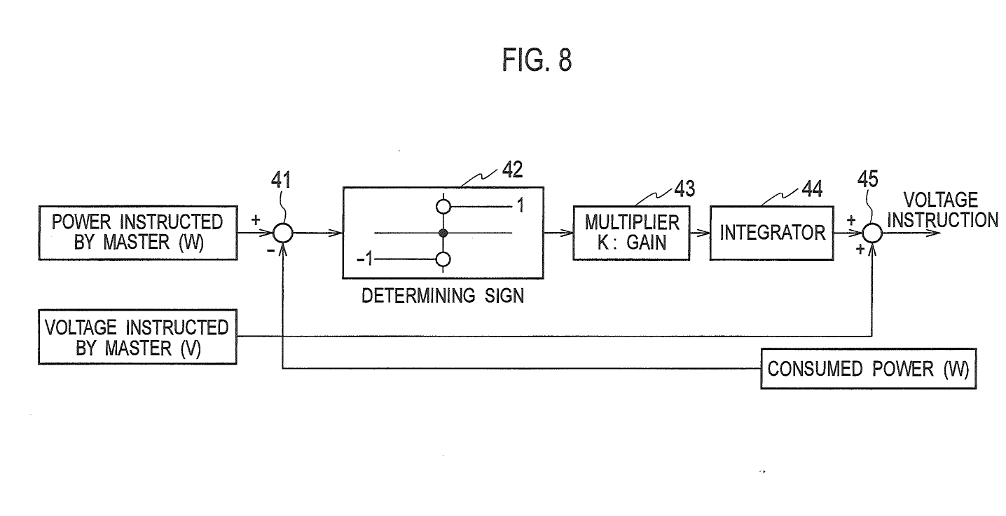

Referring to FIG. 8, each power controller section is comprised of a subtractor 41, a determination section 42 for determining signs, a multiplier 43, an integrator 44, and an adder 45. Into the subtractor 41 input are, as a minuend, the instruction value of the electric power instructed by the master controller section 14a, and, as a subtrahend, a measured value of the consumed power at the inverter generator in question. Its output is input into the determination section 42 and its sign “−1” or “1”, depending on whether it is determined to be negative or positive, is output to the multiplier 43. The multiplier multiplies the input by a coefficient “K”. The integrator 44 integrates the output by the multiplier 43 and outputs the result to the adder 45. The adder adds, this input to the instruction value of the voltage instructed by the master controller section 14a. The controller section in question, as based on this output, drives the respective switching devices. The power controller section thereby carries out feed-back control of the output power so as to meet the instruction value of the electric power instructed by the master controller section 14a.

The master controller section 14a may control the share of each controller section 14a-14d in the total output power. For example, the master controller section 14a controls the controller sections 14a-14d so that the inverter generator 101b outputs 100% of its capacity, the generator 101c 70%, and the generator 101d 50%, thereby meeting the total power demand.

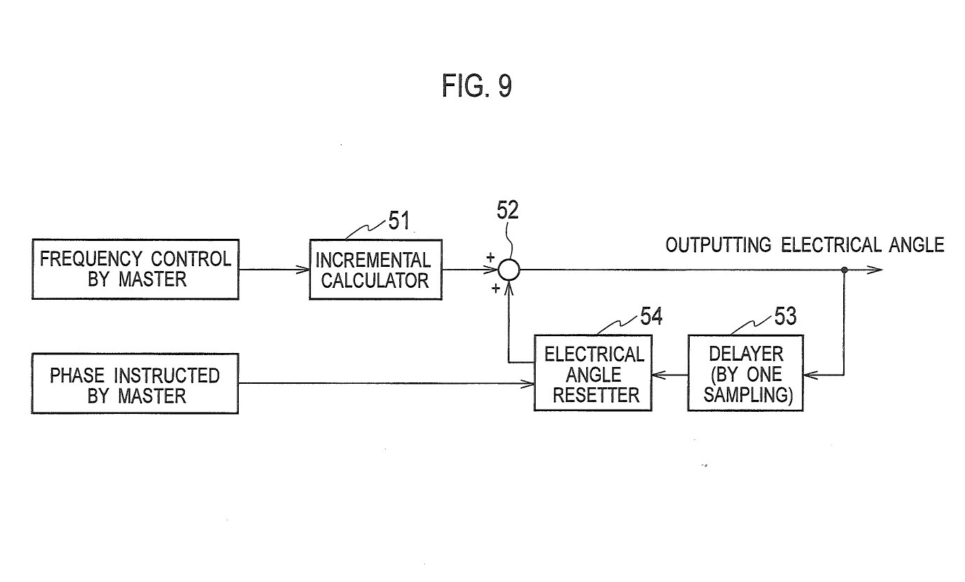

Referring to FIG. 9, each phase controller section is comprised of an incremental calculator 51, an adder 52, a delayer 53 and an electrical angle resetter 54. The master controller section 14a thereby executes feed-back control and calculates the electrical angle when a frequency control signal and a phase instruction signal are given.

More specifically, increase or decrease in the measured count is input into the incremental calculator 51. For example, in a case where the output frequency is 50 Hz and the cycle of control is 100 μsec, as one cycle is corresponding to 200 divisions, increase in pulses is 10 pulses where one electrical angle rotation is 2000 pulses. Further, on the basis of the data for the phase instruction from the master controller section 14a, by resetting the electrical angle at 0 degree, very small deviation such as a difference in clocks can be reset, thereby the electrical angle is adjusted to the electrical angle of the master controller section 14a.

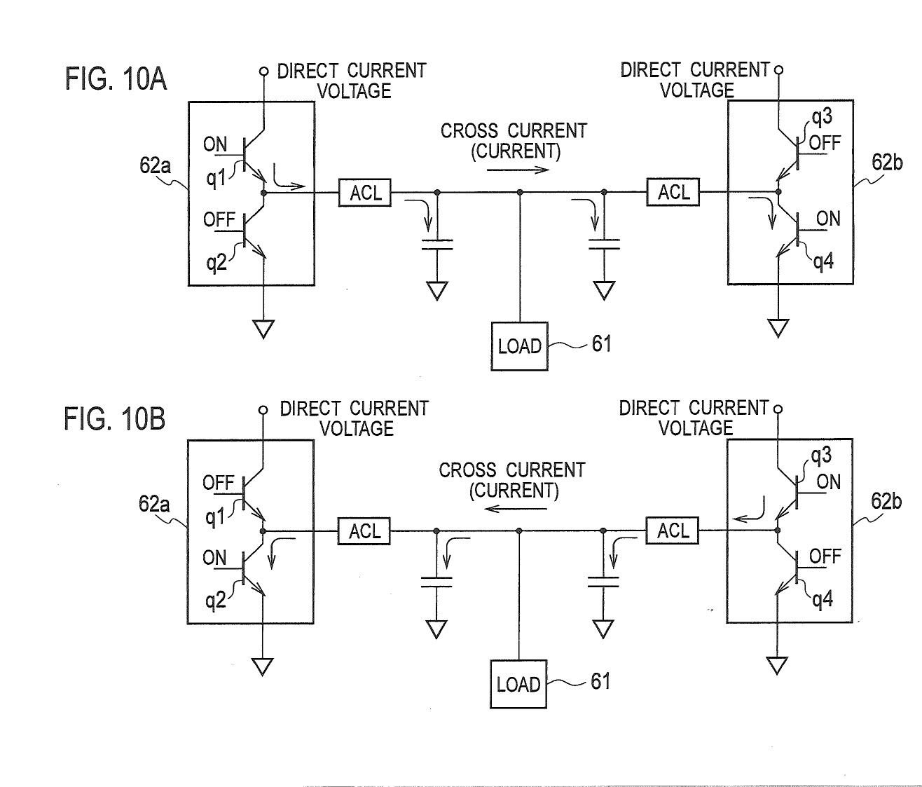

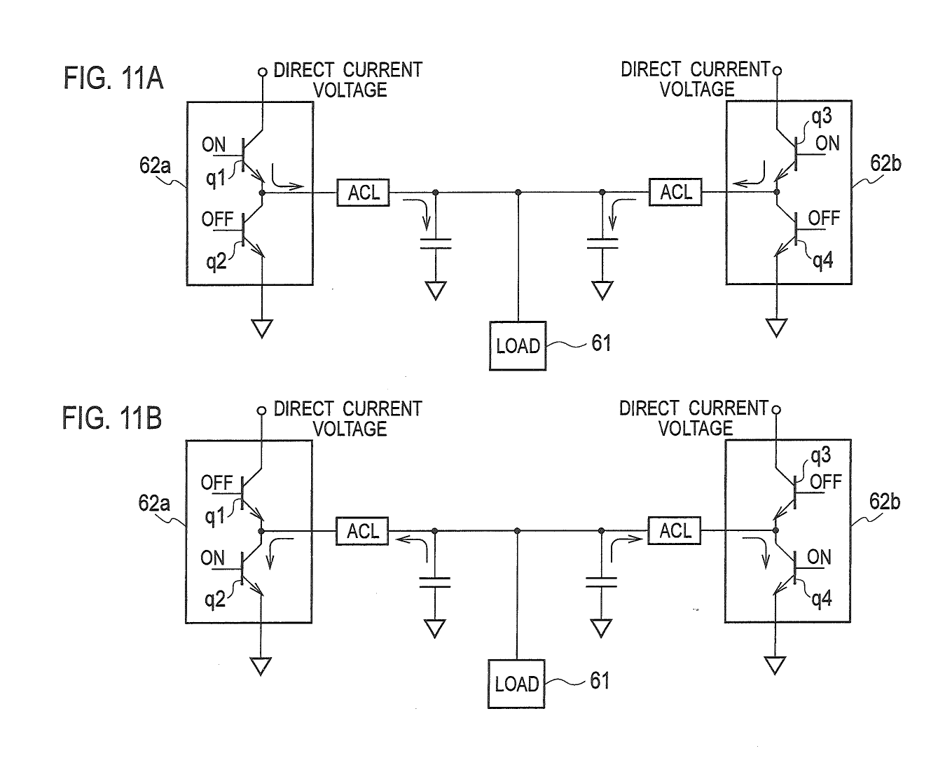

Results produced by the present embodiment will be described hereinafter with reference to FIGS. 10A, 10B, 11A and 11B. In the example illustrated in these drawings, two inverter generators 62a,62b are connected in parallel, each semiconductor switch q1,q3 in the upper arm is connected in series with each semiconductor switch q2,q4 in the lower arm, and output powers from respective centers are output to the load 61 via filters, each of which is generally comprised of an ACL (inductor) and a grounded capacitor.

The filters effectively prevent bare pulses from flowing into the load 61. The pulses could, however, considerably flow one invertor to another invertor because only the ACLs intervene between the invertor generators. The cross current (ripple current) thus flowing is not negligible.

Loss of synchronism between the inverter generators 62a,62b temporarily and frequently cause such cross current flow as shown in FIGS. 10A and 10B. As the switches q1,q4 are ON and the switches q2,q3 are OFF as shown in FIG. 10A, then the cross current flows from the inverter generator 62a to the inverter generator 62b. As the switches q2,q3 are ON and the switches q1,q4 are OFF as shown in FIG. 10B, then the cross current flows from the inverter generator 62b to the inverter generator 62a.

In contrast, if synchronism is steadily established, the switches q1,q3 are synchronously switched ON and OFF and the switches q2,q4 do the same, as shown in FIGS. 11A and 11B. Then no cross current flows.

More specifically, the present embodiment effectively prevents cross current from flowing through the parallel lines without addition of any costly devices. Moreover, as power loss by the cross current can be avoided, the present embodiment realizes more effective controllability of output power and energy efficiency.

As will be understood from the above description, the PWM carriers are not directly compared in the present embodiment but instead the processes executed individually by the inverter generators establish synchronization among the PWM carriers. It is thus unnecessary to extract one PWM carrier out of the master and compare it with another PWM carrier in the slave. The present embodiment can omit laborious work such as rewiring for such signal comparison when the system is scaled up.

Although the invention has been described above by reference to certain embodiments of the invention, the invention is not limited to the embodiments described above. Modifications and variations of the embodiments described above will occur to those skilled in the art, in light of the above teachings.

What is claimed is:

1. An inverter electric generator system comprising:
master and at least one slave inverter generators, each inverter generator including a communication section, a controller section generating a PWM carrier and an inverter circuit switched by the PWM carrier to generate an alternative current with a controlled voltage and a controlled frequency, the communication sections being mutually connected to exchange a communication data, and the inverter circuits being connected in parallel so as to collect and output the alternative currents as an electric power output,
wherein each of the controller sections is configured to synchronize any point of the PWM carrier with any bit of the communication data received by the communication section, whereby the PWM carriers of the master and the slave inverter generators mutually get synchronized.

2. The inverter electric generator system of claim 1, wherein each of the controller sections is configured to carry out a process of measuring a count of clock pulses after the bit of the communication data until the point of the PWM carrier and calculating a correction value for shifting a phase of the PWM carrier to synchronize the point of the PWM carrier with the bit of the communication data.

3. The inverter electric generator system of claim 2, wherein each of the controller sections is configured to determine whether the count is greater than zero and equal to or less than Cref/2, or greater than Cref/2 and less than Cref, where Cref is a frequency of the clock pulses divided by a frequency of the PWM carrier,
wherein each of the controller sections is configured to shift the phase of the PMW carrier by minus one or more clock pulses when the count is determined to be greater than zero and equal to or less than Cref/2, and shift the phase of the PMW carrier by one or more clock pulses when the count is determined to be greater than Cref/2 and less than Cref.

4. An inverter generator usable with another inverter generator connected in parallel, the inverter generator comprising:
a communication section capable of exchanging a communication data with a communication section of said another inverter generator;
a controller section generating a PWM carrier; and
an inverter circuit switched by the PWM carrier to generate an alternative current with a controlled voltage and a controlled frequency,
wherein the controller section is configured to synchronize any point of the PWM carrier with any bit of the communication data received by the communication section, whereby the PWM carrier gets synchronized with a PMW carrier of said another inverter generator.

5. The inverter generator of claim 4, wherein the controller section is configured to carry out a process of measuring a count of clock pulses after the bit of the communication data until the point of the PWM carrier and calculating a correction value for shifting a phase of the PWM carrier to synchronize the point of the PWM carrier with the bit of the communication data.

6. The inverter generator of claim 5, wherein the controller section is configured to determine whether the count is greater than zero and equal to or less than Cref/2, or greater than Cref/2 and less than Cref, where Cref is a frequency of the clock pulses divided by a frequency of the PWM carrier,
wherein the controller section is configured to shift the phase of the PMW carrier by minus one or more clock pulses when the count is determined to be greater than zero and equal to or less than Cref/2, and shift the phase of the PMW carrier by one or more clock pulses when the count is determined to be greater than Cref/2 and less than Cref.
